(19) United States
(12) Patent Application Publication
(10) Pub. No.: US 2020/0215781 A1
(43) Pub. Date: Jul. 9, 2020

(54) HOT-PRESS DEVICE

(71) Applicants: IHI CORPORATION, Tokyo (JP); IHI MACHINERY AND FURNACE CO., LTD., Tokyo (JP)

(72) Inventors: Toshiro TANAKA, Yokosuka-shi (JP); Hideki KAWAMOTO, Iwakuni-shi (JP); Takuma YOSHIDA, Tokyo (JP); Hiroyuki KONISHI, Yokohama-shi (JP)

(73) Assignees: IHI CORPORATION, Tokyo (JP); IHI MACHINERY AND FURNACE CO., LTD., Tokyo (JP)

(21) Appl. No.: 16/825,108

(22) Filed: Mar. 20, 2020

Related U.S. Application Data
(63) Continuation of application No. PCT/JP2018/047006, filed on Dec. 20, 2018.

(30) Foreign Application Priority Data
Dec. 25, 2017 (JP) 2017-247445

(51) Int. Cl. B30B 11/02; B22F 3/03; B30B 15/34; B30B 15/06

(52) U.S. Cl. CPC B30B 11/02; B22F 3/03; B22F 2003/031; B30B 15/065; B30B 15/34

(57) ABSTRACT

A hot-press device includes: a heating furnace; a pair of punches which includes an upper punch and a lower punch provided in the heating furnace and vertically facing each other; a lower press ram which is connected to a lower surface of the lower punch; an upper press ram which is connected to an upper surface of the upper punch; and a pressing device which is connected to any one or both of the lower press ram and the upper press ram and presses the punch so that the pair of punches are close to each other, in which the lower press ram and/or the upper press ram includes a plurality of individual press rams which are disposed at intervals, each individual press ram having one end coupled to the pair of punches.

### CROSS-REFERENCE TO RELATED APPLICATIONS

This application is a Continuation application based on International Application No. PCT/JP2018/047006, filed Dec. 20, 2018, which claims priority on Japanese Patent Application No. 2017-247445, filed Dec. 25, 2017, the contents of which are incorporated herein by reference.

### TECHNICAL FIELD

The present disclosure relates to a hot-press device.

### BACKGROUND

Patent Document 1 listed below discloses a hot-press device which performs pressure molding on a sample by two punches while heating the sample. In this hot-press device, a heater for heating is provided on sides of an upper punch and a lower punch disposed in an up-down direction, and a powdery sample is accommodated between the upper punch and the lower punch. The upper punch is pushed down by an upper hydraulic cylinder via an upper ram, and the lower punch is pushed up by a lower hydraulic cylinder via a lower ram, and thus, pressure molding (hot-press processing) is performed on the sample while heating the sample.

### DOCUMENT OF RELATED ART

### Patent Document

[Patent Document 1] Japanese Utility Model Publication No. H05-14156

### SUMMARY

In the above-described hot-press device of the related art, when pressing surfaces of the upper punch and the lower punch abutting the sample are large, that is, the hot press processing is performed on a larger sample, it is difficult to maintain uniformity in distribution of a pressing force. That is, a pressing force on the pressing surface of the upper punch is larger in the vicinity of a portion of the upper punch facing the upper ram on a rear surface side than an outer peripheral portion of this portion. In addition, a pressing force to the pressing surface of the lower punch is larger in the vicinity of a portion of the lower punch facing the lower ram on a rear surface side than an outer peripheral portion of this portion.

The present disclosure is made in consideration of the above-described circumstances, and an object thereof is to maintain the uniformity in distribution of a pressing force even when dimension of a pressing surface of a punch increase.

A hot-press device of an aspect of the present disclosure includes: a heating furnace; a pair of punches which includes an upper punch and a lower punch provided in the heating furnace and vertically facing each other; a lower press ram which is connected to a lower surface of the lower punch; an upper press ram which is connected to an upper surface of the upper punch; and a pressing device which is connected to any one or both of the lower press ram and the upper press ram and presses the punch so that the pair of punches are close to each other, in which the lower press ram and/or the upper press ram includes a plurality of individual press rams which are disposed at intervals, each individual press ram having one end coupled to the pair of punches.

In the hot-press device of the aspect, the pressing device may be connected to the upper press ram, and the upper press ram may further include: a single main press ram which is provided on a side of the pressing device; and a coupling member which couples the plurality of individual press rams and the main press ram to each other.

In the hot-press device of the aspect, each of the upper punch and the lower punch may include a pressing surface which abuts an object to be treated and a rear surface opposite to the pressing surface, the object to be treated being disposed between the upper punch and the lower punch, the pressing surface and the rear surface being rectangular, and the plurality of individual press rams may be disposed in the vicinity of four vertexes and at a center of the rear surface.

In the hot-press device of the aspect, each of the upper punch and the lower punch may include a pressing surface which abuts an object to be treated and a rear surface opposite to the pressing surface, the object to be treated being disposed between the upper punch and the lower punch, the pressing surface and the rear surface being circular, and plurality of individual press rams may be disposed at a center of the rear surface and at a plurality of equiangular positions around the center in the vicinity of a peripheral edge of the rear surface.

In the hot-press device of the aspect, the heating furnace may include: a furnace body; a heat insulating container which is provided in the furnace body and accommodates the pair of punches; and a heating element which is provided around the pair of punches in the heat insulating container, in which the heat insulating container includes a plurality of openings through which the plurality of individual press rams are inserted.

According to the present disclosure, even when dimension of a pressing surface of a punch increase, uniformity in distribution of a pressing force can be maintained.

### BRIEF DESCRIPTION OF DRAWINGS

FIG. 1 is a front view showing an overall configuration of a hot-press device A according to an embodiment of the present disclosure.

FIG. 2A is a perspective view showing a coupling structure of individual press rams and an upper punch in the embodiment of the present disclosure.

FIG. 2B is a side view showing the coupling structure of the individual press rams and the upper punch in the embodiment of the present disclosure.

FIG. 2C is a top view showing the coupling structure of the individual press rams and the upper punch in the embodiment of the present disclosure.

FIG. 3A is a top view showing a disposition example of the individual press rams in the embodiment of the present disclosure.

FIG. 3B is a top view showing another disposition example of the individual press rams in the embodiment of the present disclosure.

### DESCRIPTION OF EMBODIMENTS

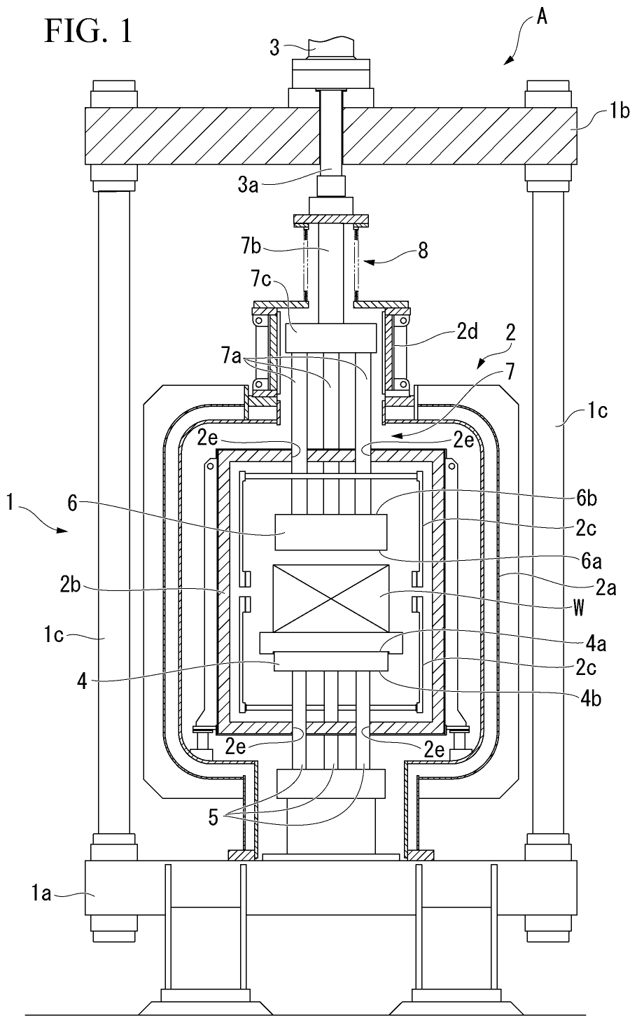

Hereinafter, an embodiment of the present disclosure will be described with reference to the drawings. As shown in FIG. 1, a hot-press device A according to the present embodiment includes a support mechanism 1, a heating furnace 2, a hydraulic cylinder 3 (pressing device), a lower punch 4, lower press rams 5, an upper punch 6, an upper press ram 7, an extensible portion 8, and the like.

The hot-press device A performs a predetermined process on an object W to be treated by pressing the object W to be treated accommodated between the lower punch 4 and the upper punch 6 in a vacuum heating environment. For example, the processing (hot press processing) performed on the object W to be treated by the hot-press device A includes diffusion bonding processing for a plurality of objects W to be treated which are stacked one above the other, sintering processing for powder-like object W to be treated, or the like. The object W to be treated in the case of the diffusion bonding processing is formed of a plurality of members stacked one above the other, and the object W to be treated in the case of the sintering processing is formed of powder accommodated in a predetermined container.

The support mechanism 1 is a metal frame which is provided so as to surround the heating furnace 2, and is a strength member which receives a reaction force of a hydraulic cylinder 3 (pressing device). As shown in the drawings, the support mechanism 1 includes a lower frame 1a, an upper frame 1b, and a plurality of coupling rods 1c. The lower frame 1a is a strength member which is provided in a lower portion of the hot-press device A and has a substantially flat plate shape having a substantially rectangular outer shape. The lower frame 1a is fixed to an installation floor of the hot-press device A. The upper frame 1b is a strength member formed in substantially the same shape as that of the lower frame 1a and is provided above the lower frame 1a so as to face the lower frame 1a in parallel with a predetermined distance.

The plurality of coupling rods 1c are provided to extend between the lower frame 1a and the upper frame 1b and fix the lower frame 1a and the upper frame 1b. For example, four coupling rods 1c are provided in the vicinity of respective vertexes (four locations) of the rectangular lower frame 1a and upper frame 1b.

The heating furnace 2 has a vertically placed cylindrical shape and is fixed on the lower frame 1a in a state where the heating furnace 2 is surrounded by the plurality of coupling rods 1c. That is, the heating furnace 2 is fixed in a state where the heating furnace 2 is interposed between the lower frame 1a and the upper frame 1b in an up-down direction and is surrounded by the plurality of coupling rods 1c in the horizontal direction.

In addition, the heating furnace 2 includes a furnace body 2a, a heat insulating container 2b, a heater 2c (heating element), and a ram accommodation portion 2d. The furnace body 2a is a vertically placed cylindrical vacuum chamber. The heat insulating container 2b is formed of a heat insulating material in a vertically placed cylindrical shape and provided in the furnace body 2a, and accommodates the lower punch 4 and the upper punch 6. The heat insulating container 2b includes a plurality of openings 2e through which the lower press rams 5 (individual press rams) and individual press rams 7a described later are inserted.

Moreover, opening/closing doors (not shown) are provided in the furnace body 2a and the heat insulating container 2b. The opening/closing doors are provided to accommodate the object W to be treated before processing in the heat insulating container 2b, that is, in the heating furnace 2, and to take out the object W to be treated after processing to the outside.

The heater 2c is a heating element which is provided around the lower punch 4 and the upper punch 6 in the heat insulating container 2b. That is, the heater 2c is disposed so as to surround the object W to be treated, the lower punch 4, and the upper punch 6, and uniformly heats the object W to be treated, the lower punch 4, and the upper punch 6. The ram accommodation portion 2d is a hollow portion protruding toward an upper portion of the heating furnace 2, and accommodates a portion of the upper press ram 7.

Here, a vacuum pump (not shown) serving as an auxiliary machine is provided in the heating furnace 2. An internal atmosphere of the heating furnace 2 is set to a predetermined vacuum atmosphere by operating the vacuum pump. In addition, the vacuum pump and the heater 2c are controlled by a controller (not shown). The controller is a software controller which controls operations of various controlled portions such as the vacuum pump and the heater 2c based on detection values of various sensors mounted on the heating furnace 2, the upper frame 1b, and the like and a dedicated control program stored in advance.

The hydraulic cylinder 3 is a pressing device which is fixed to an upper portion of the support mechanism 1, that is, to the upper frame 1b. The hydraulic cylinder 3 includes a movable rod 3a which can move up and down, and is connected to a first end (upper end) of the upper press ram 7 in a state where a guide member 8 is interposed between a distal end (lower end) of the movable rod 3a and the first end (upper end) of the upper press ram 7. The hydraulic cylinder 3 presses the upper punch 6 located on the upper side of the pair of punches, that is, the lower punch 4 and the upper punch 6, such that the upper punch 6 approaches the lower punch 4. An operation of the hydraulic cylinder 3 is controlled by the controller.

The lower punch 4 is positioned on the lower side in the heating furnace 2, and includes a pressing surface 4a which abuts a lower end of the object W to be treated and a rear surface 4b (lower surface) parallel to the pressing surface 4a. Each of the pressing surface 4a and the rear surface 4b is planar and is square when viewed from the top.

The lower press rams 5 are a plurality of rod-shaped members which couple the rear surface 4b (lower surface) of the lower punch 4 and the lower frame 1a of the support mechanism 1 to each other. The lower press rams 5 are constituted by a plurality of individual press rams which extend in the vertical direction and are disposed at predetermined intervals in the horizontal direction, and a first end (upper end) of each individual press ram is coupled to the rear surface 4b (lower surface) of the lower punch 4. The lower press rams 5 (individual press rams) are disposed in the vicinity of the four vertexes and at a center of the rectangular rear surface 4b of the lower punch 4. That is, a total of five lower press rams 5 (individual press rams), which extend in the vertical direction, are provided between the lower punch 4 and the lower frame 1a at predetermined intervals in the horizontal direction.

The upper punch 6 is positioned on the upper side in the heating furnace 2, and includes a pressing surface 6a which abuts an upper end of the object W to be treated and a rear surface 6b (upper surface) parallel to the pressing surface 6a. The pressing surface 6a and the rear surface 6b are planar and are square having the same shapes as those of the pressing surface 4a and the rear surface 4b of the lower punch 4. The upper punch 6 has a size and a posture which overlap the lower punch 4 when viewed from above or below. The upper punch 6 and the lower punch 4 are a pair of punches which faces each other in the vertical direction.

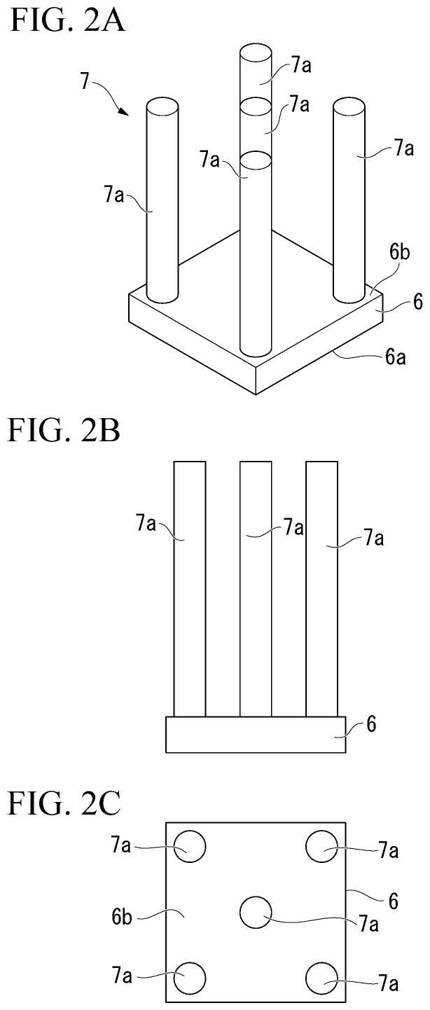

The upper press ram 7 includes a plurality of individual press rams 7a, a single main press ram 7b, and a coupling member 7c. The individual press rams 7a are rod-shaped members which are provided on the upper punch 6 side between the rear surface 6b (upper surface) of the upper punch 6 and the upper frame 1b. The plurality of individual press rams 7a extend in the vertical direction and are disposed at predetermined intervals in the horizontal direction, and a first end (lower end) of each individual press ram 7a is coupled to the rear surface 6b (upper surface) of the upper punch 6. As shown in FIGS. 2A to 2C, the individual press rams 7a are arranged in the vicinity of four vertexes and at a center of the rectangular rear surface 6b of the upper punch 6. That is, a total of five individual press rams 7a, which extend in the vertical direction, are provided between the upper punch 6 and the upper frame 1b at predetermined intervals in the horizontal direction.

The main press ram 7b is a single rod-shaped member extending in the vertical direction and provided on the upper frame 1b side, that is, the hydraulic cylinder 3 side (pressing device side) between the upper punch 6 and the upper frame 1b. The main press ram 7b is a rod-shaped member having a diameter larger than that of the individual press ram 7a, and is provided coaxially with the individual press ram 7a disposed at the center of the rear surface 6b of the upper punch 6.

The coupling member 7c is a member which couples the plurality of individual press rams 7a and the single main press ram 7b to each other. A lower surface of the coupling member 7c is connected to second ends (upper ends) of the plurality of individual press rams 7a, and an upper surface of the coupling member 7c is connected to a second end (lower end) of the single main press ram 7b.

The extensible portion 8 is an extensible cylindrical member which surrounds a peripheral surface of the main press ram 7b of the upper press ram 7. A first end of the extensible portion 8 is fixed to the movable rod 3a, and a second end of the extensible portion 8 is connected to an upper end of the ram accommodation portion 2d. As shown in the drawings, a circular opening is formed at an upper end of the ram accommodation portion 2d, and the second end of the extensible portion 8 is connected to a portion of the ram accommodation portion 2d in the vicinity of an outer periphery of the opening. The extensible portion 8 is a buffer member which ensures sealability of the heating furnace 2 while realizing upward/downward movement of the upper press ram 7. For example, the extensible portion 8 includes one cylindrical tube and a pair of cylindrical bellows provided above and below the cylindrical tube.

Next, an operation of the hot-press device A according to the present embodiment will be described in detail.

In the hot-press device A, when the object W to be treated is accommodated in the heating furnace 2 and a worker inputs a processing start instruction to the controller, each controlled portion is operated by the controller and a predetermined processing for the object W to be treated starts.

First, in the hot-press device A, the vacuum pump is operated to set an atmospheric pressure in the heating furnace 2 to a target vacuum (processing pressure), and power supply to the heater 2c starts to set an atmospheric temperature in the heating furnace 2 to a predetermined target temperature (processing temperature). In the hot-press device A, when the inside of the heating furnace 2 is set to the processing pressure and the processing temperature, an operation of the hydraulic cylinder 3 starts to press the object W to be treated with a predetermined target load (processing load).

That is, when the hydraulic cylinder 3 is operated, the upper punch 6 located above the object W to be treated in an initial state is gradually lowered, and the pressing surface 6a of the upper punch 6 comes into contact with the upper end of the object W to be treated. Here, as described above, the abutment portion 6b of the upper punch 6 is in a posture along the upper end of the object W to be treated.

Here, the upper press ram 7 includes the plurality of individual press rams 7a disposed at predetermined intervals on the rear surface 6b of the upper punch 6 which is square in top view. Accordingly, a uniform pressing force acts on the pressing surface 6a of the upper punch 6 which is square in top view.

In addition, the lower press ram 5 includes a total of five (a plurality of) individual press rams disposed at predetermined intervals on the rear surface 4b of the lower punch 4 which is square in top view. Accordingly, a uniform reaction force acts on the pressing surface 4a of the lower punch 4 which is square in top view.

Therefore, in the hot-press device A according to the present embodiment, even if dimensions of the pressing surfaces of the pair of punches, that is, the lower punch 4 and the upper punch 6 increase, uniformity in distribution of the pressing force on the pressing surface 6a can be maintained.

Moreover, the upper press ram 7 in the hot-press device A includes the plurality of individual press rams 7a, the single main press ram 7b, and the coupling member 7c which couples the plurality of individual press rams 7a and the single main press ram 7b to each other. Therefore, even when the dimensions of the pressing surfaces of the pair of punches, that is, the lower punch 4 and the upper punch 6 increase, the uniformity in distribution of the pressing force on the pressing surface 6a can be maintained and a stable pressing force can act on the object W to be treated.

Moreover, the upper press ram 7 in the hot-press device A includes a total of five individual press rams 7a which are disposed in the vicinity of the four vertexes and at the center of the rear surface 6b of the upper punch 6 which is square in top view. Accordingly, a more uniform pressing force acts on the pressing surface 6a of the upper punch 6 which is square in top view. In addition, the lower press ram 5 includes a total of five individual press rams which are disposed in the vicinity of the four vertexes and at the center of the rear surface 4b of the lower punch 4 which is square in top view. Accordingly, a more uniform reaction force acts on the pressing surface 4a of the lower punch 4 which is square in top view. According to the hot-press device A, even when the dimensions of the pressing surfaces of the pair of punches increase, the uniformity in distribution of the pressing force can be more reliably maintained.

Moreover, the heating furnace 2 in the hot-press device A includes the furnace body 2a, the heat insulating container 2b, and the heater 2c (heating element), and the heat insulating container 2b includes the plurality of openings 2e through which the individual press rams 7a of the upper press ram 7 and the lower press rams 5 (individual press rams) are inserted. Accordingly, for example, compared to a case where no heat insulating material is installed on the upper surface and lower surface of the heat insulating container 2b through which the individual press rams 7a and the lower press rams 5 (individual press rams) are provided, heat escape from the inside of the heat insulating container 2b caused by the individual press rams 7a and the lower press rams 5 (individual press rams) can be suppressed to a minimum.

Moreover, the present disclosure is not limited to the above embodiment, and for example, the following modification examples can be considered.

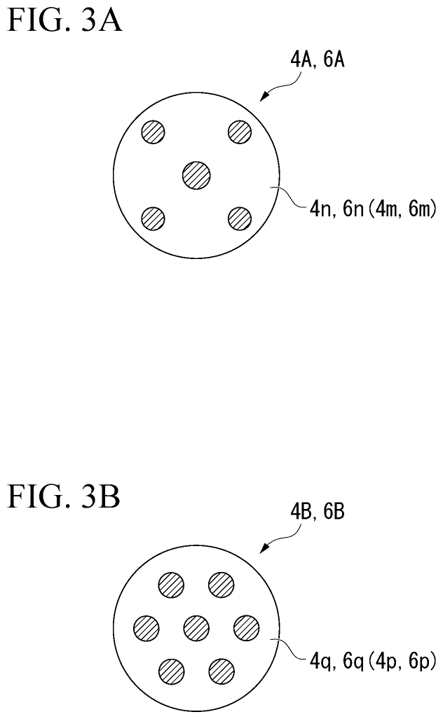

(1) In the above embodiment, the lower punch 4 and the upper punch 6 are square (rectangular) in top view. However, the present disclosure is not limited to this. Various shapes can be considered for shapes of the lower punch and the upper punch, that is, shapes of the pressing surface and the rear surface of the lower punch and the upper punch, according to a shape of the object W to be treated. For example, in a case where pressing surfaces 4m and 6m and the rear surfaces 4n and 6n are circular as a lower punch 4A and an upper punch 6A shown in FIG. 3A, the individual press rams are disposed at a center of each of the rear surfaces 4n and 6n and are disposed at equiangular positions around the center in the vicinity of a peripheral edge of each of the rear surfaces 4n and 6n.

That is, in an example of FIG. 3A, a total of five individual press rams are disposed at the center of each of the rear surfaces 4n and 6n and at every 90° around the center in the vicinity of the peripheral edge of each of the rear surfaces 4n and 6n. Further, in a case where pressing surfaces 4p and 6p and rear surfaces 4q and 6q are circular as a lower punch 4B and an upper punch 6B shown in FIG. 3B, a total of seven individual press rams may be disposed at a center of each of the rear surfaces 4q and 6q and every 60° around the center in the vicinity of a peripheral edge of each of the rear surfaces 4q and 6q. In addition, an angle division around the center of each of the rear surfaces 4q and 6q is not limited to 90° or 60°. Moreover, the individual press ram disposed at the center of each of the rear surfaces 4n and 6n may be omitted as needed.

(2) In the above embodiment, the individual press rams 7a are disposed in the vicinity of the four vertexes and at the center of the rectangular rear surface 6b of the upper punch 6. However, the present disclosure is not limited to this. For example, the individual press rams 7a may be disposed only in the vicinity of the four vertexes. In addition, in a case where a shape of the upper punch 6 in top view is polygonal other than rectangular, the individual press rams 7a may be disposed only in the vicinity of vertexes of the polygon. In addition, the individual press ram 7a may be further disposed at a center of the polygon.

(3) In the above embodiment, the upper press ram 7 includes the plurality of individual press rams 7a, the single main press ram 7b, and the coupling member 7c. However, the present disclosure is not limited to this. For example, the upper press ram 7 may include only the plurality of individual press rams 7a.

(4) In the above embodiment, the lower press ram 5 includes five individual press rams. However, the present disclosure is not limited to this. For example, the lower press ram 5 may be constituted by a single cylindrical body having a relatively large diameter. In addition, the lower press ram 5 may have the same configuration as that of the upper press ram 7.

(5) In the above embodiment, the hydraulic cylinder 3 (pressing device) is connected to only the upper press ram 7. However, the present disclosure is not limited to this. The hydraulic cylinder (pressing device) may be connected to any one or both of the lower press ram 5 and the upper press ram 7. That is, the hydraulic cylinder (pressing device) may be connected to the lower press ram 5 instead of the upper press ram 7, or the hydraulic cylinder (pressing device) may be individually connected to each of the lower press ram 5 and the upper press ram 7.

(6) In the above embodiment, the atmospheric pressure in the heating furnace 2 is set to a predetermined vacuum atmosphere by the vacuum pump. However, the present disclosure is not limited to this. For example, heating is performed under normal pressure, and the hydraulic cylinder 3 may be operated to press the object W to be treated in this heated state.

(7) In the above embodiment, the object W to be treated is pressed by the single hydraulic cylinder 3. However, the present disclosure is not limited to this. A plurality of lower pressing units each including the lower press rams 5 and the lower punch 4 may be disposed adjacent to each other, a plurality of upper pressing units each including the hydraulic cylinder 3, the upper press ram 7, and the upper punch 6 may be disposed adjacent to each other, and the object W to be treated may be pressed by the plurality of lower pressing units and the plurality of upper pressing units. In this case, a plurality of objects W to be treated may be accommodated in the heating furnace 2, and the objects W to be treated may be individually pressed by the lower pressing units and the upper pressing units.

(8) In the above embodiment, the diffusion bonding processing and the sintering processing are described as examples of the hot press processing performed by the hot-press device A. However, the present disclosure is not limited to this. The present disclosure can be used for various hot press processing in addition to the diffusion bonding processing and the sintering processing.

(9) In the above embodiment, the support mechanism 1 is provided as a strength member which receives the reaction force of the hydraulic cylinder 3 (pressing device). However, the present disclosure is not limited to this. For example, the reaction force of the hydraulic cylinder 3 (pressing device) may be received by the heating furnace 2 by providing sufficient strength to the heating furnace 2. In the case, the extensible portion 8 may be omitted.

According to the present disclosure, even when dimension of a pressing surface of a punch increase, uniformity in distribution of a pressing force can be maintained.

What is claimed is:

1. A hot-press device comprising:
a heating furnace;
a pair of punches which includes an upper punch and a lower punch provided in the heating furnace and vertically facing each other;
a lower press ram which is connected to a lower surface of the lower punch;
an upper press ram which is connected to an upper surface of the upper punch; and
a pressing device which is connected to any one or both of the lower press ram and the upper press ram and presses the punch so that the pair of punches are close to each other,
wherein the lower press ram and/or the upper press ram includes a plurality of individual press rams which are disposed at intervals, each individual press ram having one end coupled to the pair of punches.

2. The hot-press device according to claim 1,
wherein the pressing device is connected to the upper press ram,
wherein the upper press ram further includes:
a single main press ram which is provided on a side of the pressing device; and
a coupling member which couples the plurality of individual press rams and the main press ram to each other.

3. The hot-press device according to claim 1,
wherein each of the upper punch and the lower punch includes a pressing surface which abuts an object to be treated and a rear surface opposite to the pressing surface, the object to be treated being disposed between the upper punch and the lower punch, the pressing surface and the rear surface being rectangular, and
wherein the plurality of individual press rams are disposed in the vicinity of four vertexes and at a center of the rear surface.

4. The hot-press device according to claim 1,
wherein each of the upper punch and the lower punch includes a pressing surface which abuts an object to be treated and a rear surface opposite to the pressing surface, the object to be treated being disposed between the upper punch and the lower punch, the pressing surface and the rear surface being circular, and
wherein the plurality of individual press rams are disposed at a center of the rear surface and at a plurality of equiangular positions around the center in the vicinity of a peripheral edge of the rear surface.

5. The hot-press device according to claim 1,
wherein the heating furnace includes:
a furnace body;
a heat insulating container which is provided in the furnace body and accommodates the pair of punches; and
a heating element which is provided around the pair of punches in the heat insulating container,
wherein the heat insulating container includes a plurality of openings through which the plurality of individual press rams are inserted.
